(19) United States
(12) Patent Application Publication
(10) Pub. No.: US 2020/0067851 A1
(43) Pub. Date: Feb. 27, 2020

(54) SMART SOFTWARE-DEFINED NETWORK (SDN) SWITCH

(71) Applicant: ARGELA YAZILIM VE BILISIM TEKNOLOJILERI SAN. VE TIC. A.S., Istanbul (TR)

(72) Inventors: BEYTULLAH YIGIT, ISTANBUL (TR); BURAK GORKEMLI, ISTANBUL (TR); BURAK GURDAG, ISTANBUL (TR); SINAN TATLICIOGLU, ISTANBUL (TR); SEYHAN CIVANLAR, ISTANBUL (TR); A MURAT TEKALP, ISTANBUL (TR)

(21) Appl. No.: 16/108,001

(22) Filed: Aug. 21, 2018

(51) Int. Cl. H04L 12/931; H04L 12/721; H04L 12/715; H04L 12/725; G06F 15/18; H04L 12/24

(52) U.S. Cl. CPC H04L 49/355; H04L 45/38; H04L 45/64; H04L 63/0236; G06F 15/18; H04L 41/0654; H04L 45/306

(57) ABSTRACT

A new component is provided within a switch that ‘learns’ from the messages between the switch and the controller regarding how to behave like a controller under different network conditions and how to optimize the switch flow tables by implementing techniques like aggregation to save memory space, wherein the new component can act as a ‘proxy controller’ that resides within the switch. This new component can be activated when a specific trigger happens, wherein the trigger is programmable into the switch. After the trigger is active, the proxy/local controller starts undertaking some or all of the roles of the controller until the trigger is deactivated. Because different types of triggers can be programmed, the new component can have one or more of the control functions. The teaching of the new component (which can be a hardware chip or software) is performed outside the switch using machine-learning techniques (e.g. deep learning).

### BACKGROUND OF THE INVENTION

### Field of Invention

The present invention relates generally to a Software Defined Network (SDN) and specifically to a switch that has a local intelligence that is trained using machine learning to provide one or a plurality of functions of the controller.

### Discussion of Related Art

Software Defined Network (SDN) currently refers to networks in which the control plane is decoupled from the data plane of forwarding functions, and assigned to a logically centralized controller, which is the ‘brain’ of the network. The SDN architecture, with its software programmability, provides agile and automated network configuration and traffic management that is vendor neutral and based on open standards. Switches in SDN forward data packets only according to instructions they receive from one or more controllers using a standardized protocol such as OpenFlow. A controller configures the packet forwarding behavior of switches by setting packet-processing rules in the form of ‘match-action’ in a so-called ‘flow table’. The match criteria are multi-layer traffic classifiers that inspect specific fields in the packet header (source MAC address, destination MAC address, VLAN ID, source IP address, destination IP address, source port, etc.), and identify the set of packets to which the specified ‘actions’ will be applied. The actions may involve modification of the packet header and/or forwarding through a defined output port. Each packet stream that matches the criteria is called a ‘flow’. If there are no rules defined for a particular packet stream, depending on the table-miss configuration set by the network administrator, the switch receiving that packet stream will either discard it or forward it along the control network to the controller requesting instructions on how to forward them.

The controller is the central control point of an SDN and hence vital in the proper operations of network switches. The controller is directly or indirectly attached to each switch forming a control network in which the controller is at the center and all switches are at the edges. OpenFlow protocol runs bi-directionally between the controller and each switch on a secured or unsecured TCP channel. If the switch is a P4 switch, the controller can directly program the hardware of the switch by sending a P4 program. OpenFlow and P4 Runtime are two examples of control communications protocols.

One of the key attributes of Software Defined Networks (SDN) is the decoupling of route determination and packet forwarding. Route determination function is performed within the controller. The calculated routes are mapped into so called flow rules, within the controller, which form the set of instructions prepared for each individual network switch, precisely defining where and how to forward the packets of each flow (a traffic stream) passing through that switch. The ‘where’ part defines to which outgoing port of switch the packet must be sent, whereas the ‘how’ part defines what changes must be performed to each packet matching a criteria in the flow table (changes in the header fields, for example). The controller sends the flow rules to each network switch and updates them as the network map changes. Route determination is attributed to the control plane, i.e., the controller, whereas forwarding is attributed to the data plane, i.e., the switches. When the switch can't find a flow table entry that applies to a particular flow, it sends the packets of the flow (unknown packets) towards the controller in the form of ‘Packet-In’ messages requesting instructions as to how to forward these packets. Once the controller makes a routing determination about these packets, it sends each of the packets back to the switch in a ‘Packet-Out’ messages along with associated flow table entries.

SDN architecture has several benefits such as global network visibility when it comes to route determination, network-wide routing consistency, and easy support for QoS services, network slicing and network virtualization. There are also notable drawbacks due to its inherent centralized control architecture: (1) the controller becomes a single-point of failure. If the controller(s) fails, then the entire network can't properly function; (2) the controller can be a target for security attacks (such as Distributed DOS); (3) there is latency in switch-to-controller (control) communications which can be important when control connections are congested or the controller is too busy. DoS attacks have been around since the early days of Internet. However, the methods to conduct and obfuscate such attacks have become more and more sophisticated as time goes by to become Distributed DoS (DDoS) attacks that engage many hosts at the same time. Such attacks are constructed in such a way that they can't be addressed by traditional on premises solutions.

DDoS attacks are generally performed with the help of a large number of compromised machines (zombies). The attacker remotely commands a number of these infected hosts to send bogus packet traffic towards a target IP address. The attack causes incoming traffic to flood the target host from hundreds of source hosts at the same time effectively making it impossible to eliminate the attack by simply blocking a single source IP address. More importantly, it is very difficult to distinguish legitimate packet traffic from the attack traffic. If the target host is the controller, it becomes too busy dealing with the attacker hosts' requests that it does not have processing power remaining to respond to legitimate requests from the switches. This leads to delays, outages, and in some cases a complete controller shutdown.

If the controller is made unreachable by a Distributed Denial of Service (DDoS) attack, the entire data network will be affected. The attack will exhaust not only the controller processing resources but also the control network bandwidth. Note that the controller acts essentially as a ‘default router’ when a switch does not know how to forward a packet. The table-miss causes continuously flooding the controller with undesirable control traffic in the form of Packet-In messages. The DDoS attack towards the controller most likely takes advantage of table misses.

Embodiments of the present invention are an improvement over prior art systems and methods.

### SUMMARY OF THE INVENTION

In one embodiment, the present invention provides an SDN switch comprising: (a) a plurality of ports to send/receive data, an incoming port within the plurality of ports, receiving a data packet from a first switch, and an outgoing port within the plurality of ports, sending the data packet to a second switch; (b) a forwarding engine to perform packet forwarding from the incoming port to the outgoing port according to one or more rules in a locally stored flow table; (c) another port in the plurality of ports to send/receive control packets to/from a centralized controller to construct the locally stored flow table; (d) a local controller to provide at least one control function of the centralized controller internally, wherein the local controller is trained externally by machine-learning for the at least one control function that is specific to the SDN switch; and (e) a trigger function to activate the local controller when a trigger is observed within the SDN switch and to divert at least a portion of a control traffic towards the local controller to provide the at least one control function, in lieu of sending the portion of the control traffic to the centralized controller.

In another embodiment, the present invention provides a method as implemented in an SDN switch, the SDN switch comprising: (a) a plurality of ports to send/receive data, an incoming port within the plurality of ports, receiving a data packet from a first switch, and an outgoing port within the plurality of ports, sending the data packet to a second switch; (b) a forwarding engine to perform packet forwarding from the incoming port to the outgoing port according to one or more rules in a locally stored flow table; (c) another port in the plurality of ports to send/receive control packets to/from a centralized controller to construct the locally stored flow table, (d) a local controller to provide at least one control function of the centralized controller internally, wherein the local controller is trained externally by machine-learning for the at least one control function that is specific to the SDN switch; and (e) a trigger function to activate the local controller when a trigger is observed within the SDN switch and to divert at least a portion of a control traffic towards the local controller to provide the at least one control function, in lieu of sending the portion of the control traffic to the centralized controller, the method comprising: (a) when the trigger is activated, sending at least a portion of the control traffic to the local controller residing in the SDN switch, and when the trigger is not activated, sending all control traffic to the centralized controller; and (b) when the trigger is de-activated after being activated, then switch-back all control traffic from the local controller to the centralized controller.

In yet another embodiment, the present invention provides a method as implemented in an SDN switch, the SDN switch comprising: (a) a plurality of ports to send/receive data, an incoming port within the plurality of ports, receiving a data packet from a first switch, and an outgoing port within the plurality of ports, sending the data packet to a second switch; (b) a forwarding engine to perform packet forwarding from the incoming port to the outgoing port according to one or more rules in a locally stored flow table; (c) another port in the plurality of ports to send/receive control packets to/from a centralized controller to construct the locally stored flow table, (d) a local controller to provide at least one control function of the centralized controller internally, wherein the local controller is trained externally by machine-learning for the at least one control function that is specific to the SDN switch; and (e) a trigger function to activate the local controller when a trigger is observed within the SDN switch and to divert at least a portion of a control traffic towards the local controller to provide the at least one control function, in lieu of sending the portion of the control traffic to the centralized controller, the method comprising: (a) switching over from using a centralized controller to a local controller residing within the SDN switch when one of or a plurality of pre-programmed triggers is activated; (b) when any of the pre-programmed triggers in (a) are activated, sending only a corresponding control traffic to the local controller while sending rest of the control traffic to the centralized controller; and (c) when any of the pre-programmed triggers in (a) are de-activated after being activated, then switching-back that corresponding control traffic from the local controller to the centralized controller.

In yet another embodiment, the present invention provides an article of manufacture comprising non-transitory computer storage medium storing computer readable program code which, when executed by a processor in a single node, implements an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table; the non-transitory computer storage medium comprising: (a) computer readable program code implementing a local controller to provide at least one control function of the centralized controller internally, wherein the local controller is trained externally by machine-learning for the at least one control function that is specific to the SDN switch; and (b) computer readable program code implementing a trigger function to activate the local controller when a trigger is observed within the SDN switch and to divert at least a portion of a control traffic towards the local controller to provide the at least one control function, in lieu of sending the portion of the control traffic to the centralized controller.

In yet another embodiment, the present invention provides an article of manufacture comprising non-transitory computer storage medium storing computer readable program code which, when executed by a processor in a single node, implements a method as implemented in an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller, the non-transitory computer storage medium comprising: (a) when the trigger is activated, computer readable program code sending at least a portion of the control traffic to the local controller residing in the SDN switch, and when the trigger is not activated, sending all control traffic to the centralized controller; and (b) when the trigger is de-activated after being activated, then computer readable program code switching-back all control traffic from the local controller to the centralized controller.

In yet another embodiment, the present invention provides an article of manufacture comprising non-transitory computer storage medium storing computer readable program code which, when executed by a processor in a single node, implements a method as implemented in an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller, the non-transitory computer storage medium comprising: (a) computer readable program code switching over from using a centralized controller to a local controller residing within the SDN switch when one of or a plurality of pre-programmed triggers is activated; (b) when any of the pre-programmed triggers in (a) are activated, computer readable program code sending only a corresponding control traffic to the local controller while sending rest of the control traffic to the centralized controller; and (c) when any of the pre-programmed triggers in (a) are de-activated after being activated, computer readable program code switching-back that corresponding control traffic from the local controller to the centralized controller.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates a typical router according to prior art.

FIG. 2 illustrates a simple SDN according to prior art.

FIG. 3 illustrates the SDN switch according to this invention showing additional components.

FIG. 4 illustrates the activation of local controller upon trigger function activation according to the present invention.

FIG. 5 illustrates the components for training of the local controller according to the present invention.

FIG. 6 illustrates the update procedure of the local controller according to the present invention.

FIG. 7 illustrates the interfaces of local controller.

FIG. 8 depicts the flow chart of the single-trigger method of the switch according to the present invention.

FIG. 9 depicts the flow chart of the multiple-trigger method of the switch according to the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

As used herein, a network device such as a switch, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers. A component of a network device can be implemented as a software function or as a hardware function.

This invention provides a new component within the switch that ‘learns’ from the messages between the switch and the controller how to behave like a controller under different network conditions and how to optimize the switch flow tables by implementing techniques like aggregation to save memory space and can act essentially as a ‘proxy controller’ that resides onboard, i.e., within the switch. This new component is normally neither in the data nor in the control path. It does not interfere with the normal operation of the switch, but can be activated when a specific trigger happens, wherein the trigger is programmable into the switch. After the trigger is active, the proxy/local controller starts undertaking some or all of the roles of the controller until the trigger is deactivated. Because different types of triggers can be programmed, the new component can have one or more of the control functions. The teaching of the new component (which can be a hardware chip or software) is performed outside the switch using machine-learning techniques, one of which is deep learning. A local controller's operation is switch-specific and completely localized. Neighbor local controllers do not need to interact.

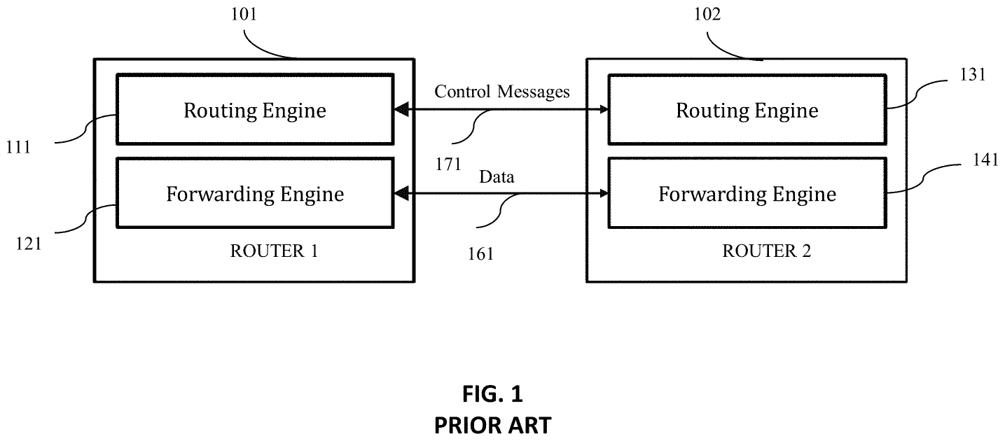

FIG. 1 illustrates simplified functional block diagram of routers 101 and 102, wherein router 101 has forwarding engine 121 and routing engine 111, and router 102 has forwarding engine 141 and routing engine 131. Forwarding engines 121 and 131 apply filtering rules and routing policies to each incoming and outgoing packet, and forward packets to the next hop switch according to local routing tables. Routing engines 111 and 131 on the other hand provide three main functions: (a) create the routing table to perform route filtering and switching for each incoming data packet and to direct the packet to the appropriate outgoing interface for transmission to the next hop on the route; (b) keep the routing table current and control the routing protocols that run on the router; and (c) provide control and monitoring functions for the router. The routing engines between two adjacent routers communicate with interface 171 using standard routing protocols such as Open Shortest Path First (OSPF) and Border Gateway Protocol (BGP). Forwarding engines between two adjacent switches communicate with interface 161 to send and receive IP packets for data forwarding. Although interfaces 161 (data) and 171 (control/routing) are separately illustrated and functionally distinct, physically they run on the same transmission facility interconnecting the two routers.

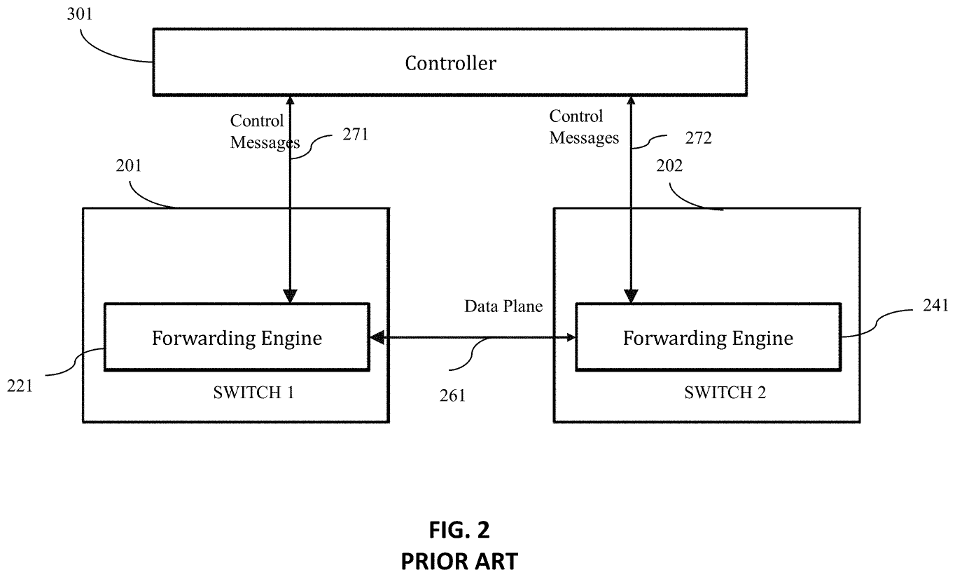

In contrast to traditional routing infrastructure of FIG. 1, FIG. 2 illustrates the Software Defined Network (SDN) functional block diagram of two switches, 201 and 202 interconnected with transmission facility 261. While switch 201 has forwarding engine 221 and switch 202 has forwarding engine 241, neither of these two switches has a routing engine. Controller 301 carries out all the routing functions in communications with both switches 201 and 202 via control channels 271 and 272, respectively. The routing function is therefore completely centralized. The switches do not need to communicate routing information with their neighbors.

Controller makes much more intelligent routing decisions by collecting the topology of the entire network as compared to hop-by-hop routing. Then, it disseminates the routing information pertinent to a particular switch in the form of flow tables. Thus, a switch does not need the entire routing table. Contrasting SDN to a classical routed network, SDN provides a ‘centralized’ control of routing wherein classical routed network provides a ‘hop-by-hop’ control of routing. This invention takes it a step further by claiming a ‘localized’ control of routing ‘trained’ by the specific switch's routing history and from other relevant data sources. This localized control actions apply to a specific switch and can be different across different switches.

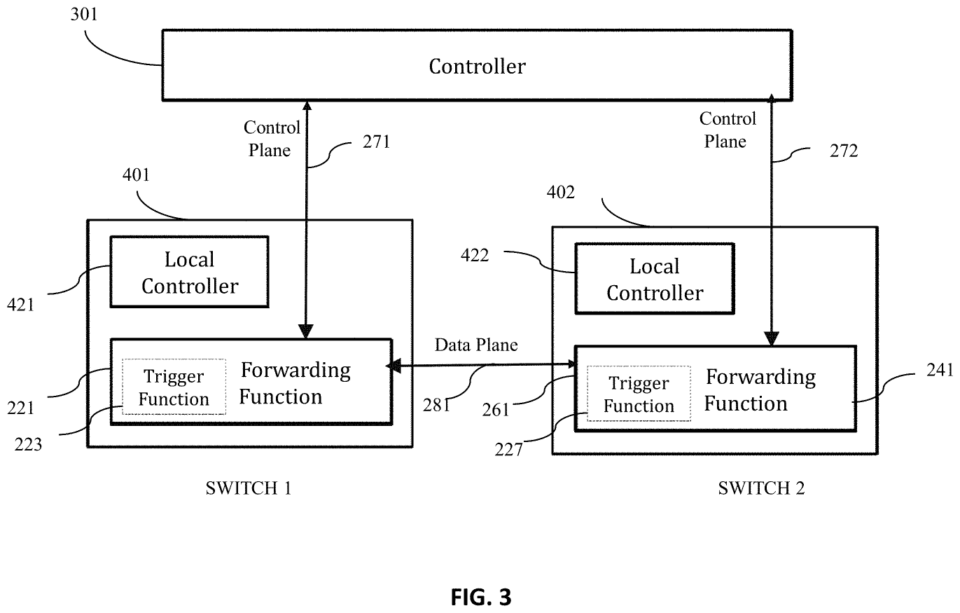

One of the shortcomings of the centralized control architecture of an SDN is the controller becoming a single point of failure and being open to potential security attacks such as DDoS. In this invention, this shortcoming is remedied by introducing a localized control component in the switch. For lack of a better term, this intelligent component is named local controller. In FIG. 3, the network of FIG. 2 is recreated with the local controller in both switches 401 and 402 attached to controller 301 via control connections 271 and 272. Under normal operations, switches 401 and 402 use controller 301 for routing functions just as in the normal SDN operations. In conjunction with the forwarding engine, in a preferred embodiment of this invention, there is a new component called ‘trigger function’ that is deployed in the switch, which shifts the switch operations from using the centralized controller to the local controller for a specific reason. In an embodiment, the trigger function can be programmed into the forwarding engine.

According to a particular embodiment of this invention, and as illustrated in FIG. 3, switch 401 has two new components: local controller 421 and trigger function 223. Similarly, switch 402 has two new components: local controller 422 and trigger function 227. Although in this embodiment both switches are shown to have the components of this invention, in another possible embodiment some switches may have these components while other switches may be prior art SDN switches (such as switch 201 and 202 illustrated in FIG. 2) that can only communicate with the centralized controller. Note that the local controllers 421 and 422 are specific to switches 401 and 402, respectively, and therefore are ‘trained’ separately according to the operations of these two switches resulting in (possibly) two different models.

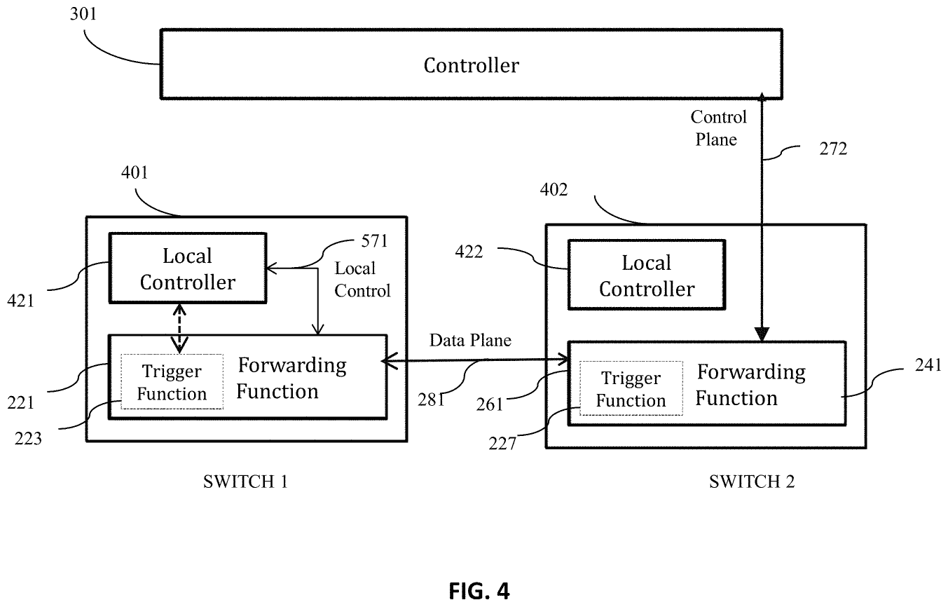

When the trigger function is not active, the local controller stays in a completely passive (de-active) state and the switch communicates with the centralized controller as shown in FIG. 3. However, if the trigger function is activated in switch 401, as illustrated in FIG. 4, then the switch 401 shifts from the normal mode of using the centralized controller to using the local controller until the trigger is deactivated (or cleared) for a set of specified control functions, while switch 402 stays in the normal mode. For example, forwarding engine 221 sends ‘packet-in’ control messages to local controller 421 as opposed to centralized controller 301. If controller 301 fails, both switches 401 and 402 will start using the local controllers.

Various embodiments of trigger function 223 are viable. For example, it can be implemented in such a way that its sole function is to protect the centralized controller against a DDoS attack by diverting control traffic resulting from attack traffic away from the centralized controller and towards the local controller say when the volume of control messages over a specified time period exceeds a threshold. Another possible implementation is one in which the trigger function is activated when the Ternary Content Addressable Memory (TCAM) capacity is close to exhaustion, in which case the local controller loads all local flow tables (forwarding information base (FIB)) from the forwarding engine, and aggregates fragmented flow table entries as much as possible to fit into the TCAM. The aggregation is a concept known in prior art and therefore not elaborated here. Unfortunately, the controller updates flow table entries incrementally as traffic patterns realize, which causes the flow tables to grow in size over time. The centralized controller can certainly aggregate routes each time there is an incremental routing update, but this will cause a significant resource waste both by the controller and the switch. Therefore, it is not a commonly implemented practice.

The trigger function can be implemented in such a way that the local controller may only handle a subset of control functions, while all other control functions are still provided by the central controller. Many other embodiments of the trigger function are possible and covered by this invention.

A key aspect of this invention is the training of the local controller by using machine learning to teach a desired behavior for a ‘specific’ control function or a plurality of control functions. If the local controller provides a plurality of control functions, then correspondingly, a plurality of trigger functions may be needed. The local controller may not necessarily have all control functions of a centralized controller. It may not even have, for example, the basic controller function of dynamic route computation, but may have other processing intensive functions that are more suitably implemented locally. Each switch's local controller is trained according to the specific traffic patterns of that switch.

The trigger function depends on the functionality of the local controller. It can be implemented, for example, as a threshold violation, wherein the threshold is the large increase in number of control or data packets during a specified time interval. This specific threshold can be an indicator of a DDoS attack. Other triggers can be the number of table-miss within the forwarding engine over a time interval. Many other triggers can be designed. For example, the total number of flow table entries or the TCAM capacity usage can be used as a trigger. A heavy congestion or failure of the control connection, or heavy congestion or failure of the controller can also be triggers. The trigger function can be manually activated and deactivated by the system administrator. Multiple triggers can also be defined. Just like the local controller, trigger function can also be trained by machine learning.

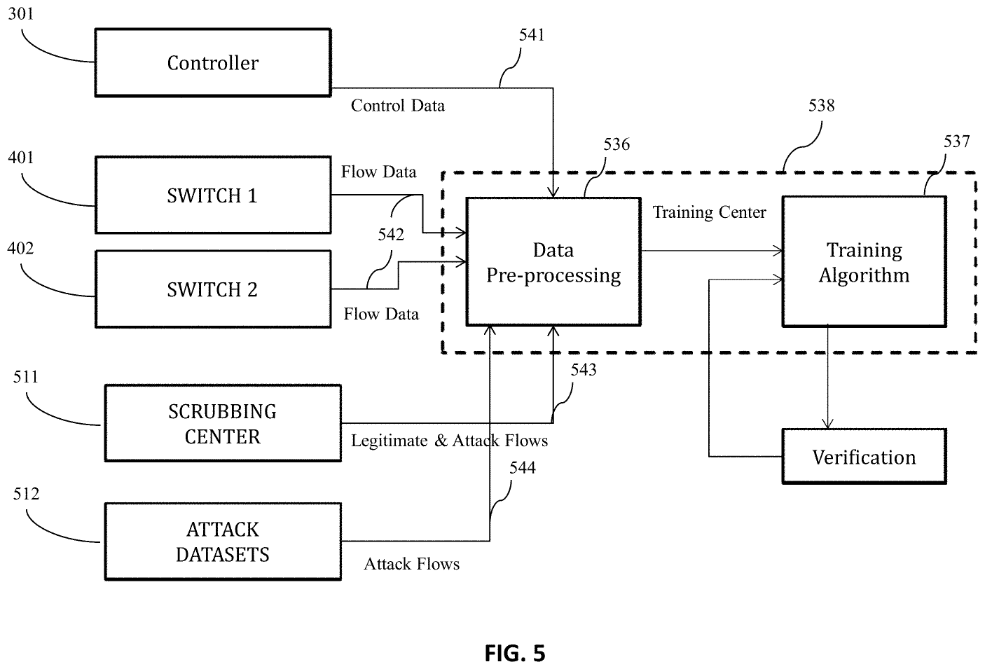

An exemplary local controller training system employs machine-learning techniques as illustrated in FIG. 5. Machine learning is a type of artificial intelligence (AI) technique that allows a software application (or a special purpose hardware) to progressively become accurate in detecting patterns without being explicitly programmed. An algorithm is used that can receive large amounts of input data and use statistical analysis to predict an output value within an acceptable range. The training results in a so-called ‘model’ that comprises the brain of the machine.

The training data, which is the IP packet flows, can be obtained from various real/live sources such as controller 301, switch 401, scrubbing center 511, and simulated non real-time sources such as attack datasets 512, and fed into data pre-processing unit 536 which selects appropriate training data by selecting portions of data (specific flows and/or specific parts of the packets such as header information, or various counters and feeds into training algorithm 537 in training center 538. Neighbor switch data may also be fed as relevant data (illustrated in the figure as switch 402 data).

The training and verification stages are part of the machine learning cycle, and well published in prior art. A subset of the overall data is held back as verification data, and not used during training. Once the model is fit using the training data, the final model is tested on the verification data for accuracy. The training and verification data can be randomly divided. The training can be repeated periodically as more relevant data becomes available.

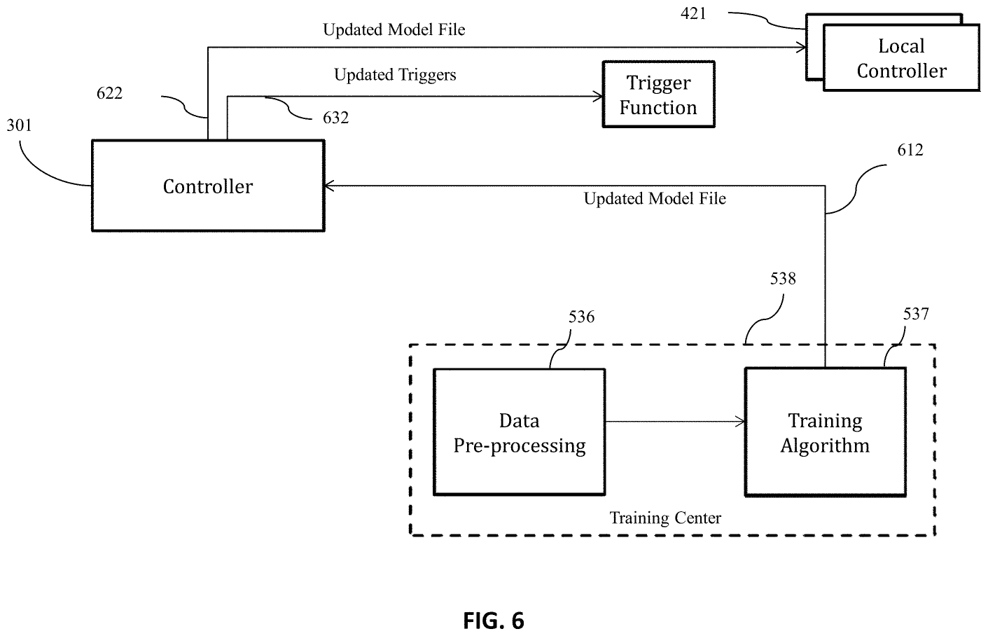

The training algorithm feeds the updated model file to controller 301 once a successful training cycle is completed. As illustrated in FIG. 6, controller 301 updates both the trigger function and the local controller according to the updated model files. The file can be transferred, for example, in JSON format.

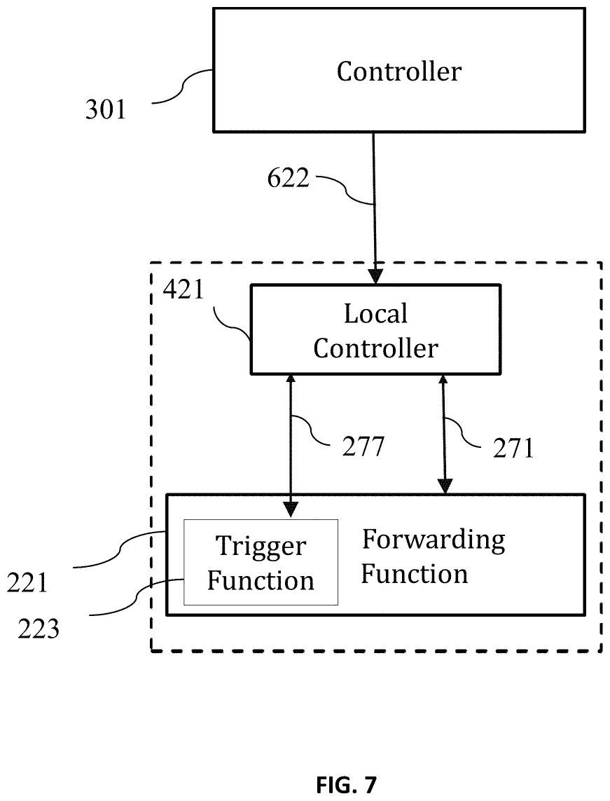

Local controller 421 has three key interfaces as illustrated in FIG. 7. It can receive (some or) all control data through interface 271. This is the same interface as the controller to switch interface (e.g., using OpenFlow or P4 Runtime protocols). When Trigger Function 223 triggers activation of local control mode, forwarding engine 221 starts sending control flows directly to local controller. In an embodiment of the switch, an explicit activation of the local controller is achieved by Trigger Function 223 sending an ‘activation’ message to the Local Controller using interface 277. Similarly, Trigger Function 223 can explicitly de-activate the local controller mode (to enable return back to the normal control mode) by sending a message to the Local Controller using interface 277. In another possible embodiment, forwarding engine 221 sending a first control message towards the local controller implicitly causes activation. In contrast, a long enough period of ‘no control messages’ towards the local controller causes de-activation of local controller mode. Various other embodiments are possible. Upon receiving these flows, local controller 421 can process them according to its trained mode, and respond to forwarding engine 221 by sending appropriate policies, forwarding and filtering rules or other actions for data flows according to the regular SDN control interface protocol. The local controller also communicates with centralized controller 301 to receive updated model files or possibly other information pertaining to the operations of the local controller. Local controller 421 can be implemented in software or a deep learning chipset specifically designed for improved performance of training speed and data volume. All such implementations are assumed to be covered by the patent.

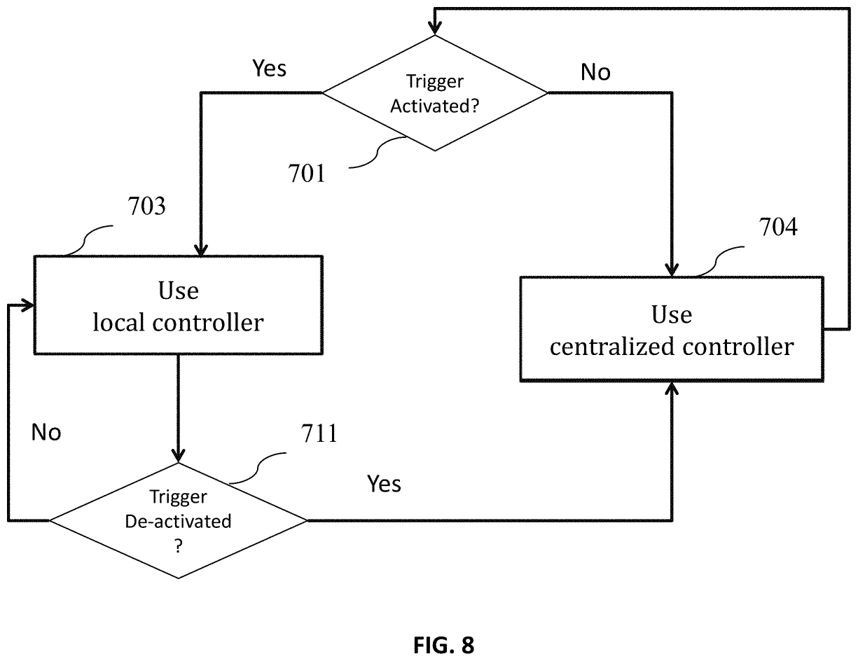

FIG. 8 shows a simple flow-chart of the scenario in which only one trigger is implemented to switch-over from the centralized controller to the local controller mode. In step 701, the switch checks to determine if the trigger is reached (or activated). If not, the centralized controller continues to serve the switch as shown in step 704. Otherwise, the switch starts using the local controller in step 703. Subsequently, if the trigger is no longer applicable in step 711, the operation returns to the centralized controller. Otherwise, the local controller continues to serve the switch. In another embodiment, the switch does not continuously check the trigger status, but instead the trigger alerts the forwarding engine when needed.

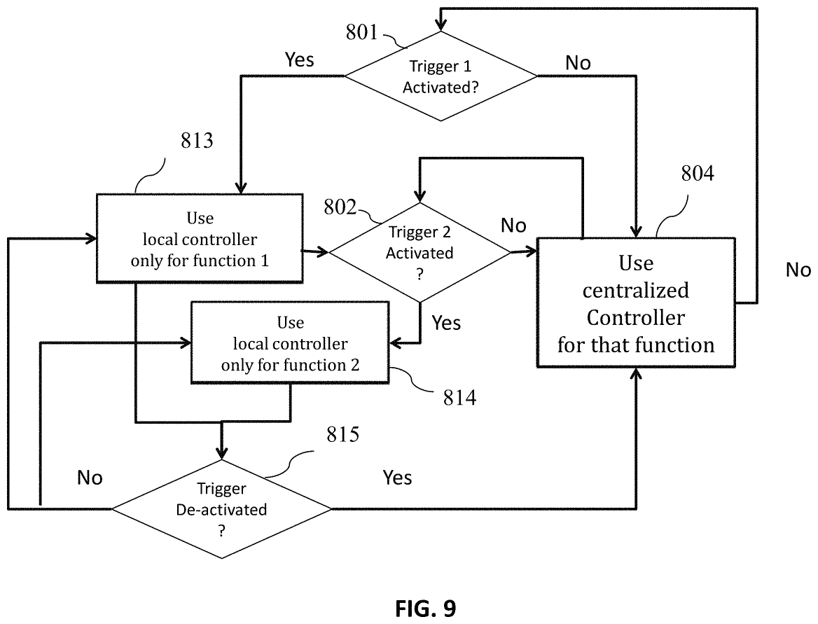

FIG. 9 shows a simplified flow-chart of the scenario in which two different triggers are implemented to cause a switch-over from the centralized controller to the local controller. In step 801, the switch checks to determine if the trigger 1 is reached (or activated). If not, the centralized controller continues to serve the switch as shown in step 804 for function 1. Next, in step 802, the switch checks to determine if the trigger 2 is reached (or activated). If not, the centralized controller continues to serve the switch as shown in step 804 for function 2 as well. If trigger 1 is reached, the operation switches over only for function 1 towards the local controller while the rest of the control functions remain with the centralized controller as shown in step 813. If trigger 2 is reached, the operation switches over function 2 to the local controller while the rest of the control functions remain with the centralized controller as shown in step 814. Subsequently, if any of the triggers is no longer active in step 815, the corresponding function(s) return from the local controller back to the centralized controller. In another embodiment, the switch does not continuously check the trigger status, but instead the triggers alert the forwarding engine when needed.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

In one embodiment, the present invention provides an article of manufacture comprising non-transitory computer storage medium storing computer readable program code which, when executed by a processor in a single node, implements an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table; the non-transitory computer storage medium comprising: (a) computer readable program code implementing a local controller to provide at least one control function of the centralized controller internally, wherein the local controller is trained externally by machine-learning for the at least one control function that is specific to the SDN switch; and (b) computer readable program code implementing a trigger function to activate the local controller when a trigger is observed within the SDN switch and to divert at least a portion of a control traffic towards the local controller to provide the at least one control function, in lieu of sending the portion of the control traffic to the centralized controller.

In another embodiment, the present invention provides an article of manufacture comprising non-transitory computer storage medium storing computer readable program code which, when executed by a processor in a single node, implements a method as implemented in an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller, the non-transitory computer storage medium comprising: (a) when the trigger is activated, computer readable program code sending at least a portion of the control traffic to the local controller residing in the SDN switch, and when the trigger is not activated, sending all control traffic to the centralized controller; and (b) when the trigger is de-activated after being activated, then computer readable program code switching-back all control traffic from the local controller to the centralized controller.

In yet another embodiment, the present invention provides an article of manufacture comprising non-transitory computer storage medium storing computer readable program code which, when executed by a processor in a single node, implements a method as implemented in an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller, the non-transitory computer storage medium comprising: (a) computer readable program code switching over from using a centralized controller to a local controller residing within the SDN switch when one of or a plurality of pre-programmed triggers is activated; (b) when any of the pre-programmed triggers in (a) are activated, computer readable program code sending only a corresponding control traffic to the local controller while sending rest of the control traffic to the centralized controller; and (c) when any of the pre-programmed triggers in (a) are de-activated after being activated, computer readable program code switching-back that corresponding control traffic from the local controller to the centralized controller.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of a smart SDN switch. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. An SDN switch comprising:
(a) a plurality of ports to send/receive data, an incoming port within the plurality of ports, receiving a data packet from a first switch, and an outgoing port within the plurality of ports, sending the data packet to a second switch;
(b) a forwarding engine to perform packet forwarding from the incoming port to the outgoing port according to one or more rules in a locally stored flow table;
(c) another port in the plurality of ports to send/receive control packets to/from a centralized controller to construct the locally stored flow table;
(d) a local controller to provide at least one control function of the centralized controller internally, wherein the local controller is trained externally by machine-learning for the at least one control function that is specific to the SDN switch; and
(e) a trigger function to activate the local controller when a trigger is observed within the SDN switch and to divert at least a portion of a control traffic towards the local controller to provide the at least one control function, in lieu of sending the portion of the control traffic to the centralized controller.

2. The SDN switch of claim 1, wherein the trigger function is implemented as a violation of a threshold, wherein the threshold is any of the following: an increase in number of data packets, an increase in the number of control packets, an increase in the number of table-miss during a specified time interval, an increase in a total number of flow table entries, or an increase in a Ternary Content Addressable Memory (TCAM) capacity usage.

3. The SDN switch of claim 1, wherein the trigger function is implemented as any of the following: a detection of heavy congestion of a control connection associated with the SDN switch, a detection of failure of a control connection associated with the SDN switch, a detection of heavy congestion of the centralized controller, or a detection of failure of the centralized controller.

4. The SDN switch of claim 1, wherein the trigger function is programmed into the switch and updated time-to-time by either the centralized control or via a manual interface.

5. The SDN switch of claim 1, wherein the local controller and the trigger function are trained external to the SDN switch using machine learning with a training dataset, the training dataset is at least control packets of the SDN switch collected over a period of time from any of the following: the centralized controller, a scrubbing center, or a simulated dataset.

6. The SDN switch of claim 5, wherein the training dataset is pre-processed to discard repetitive, useless or corrupt data.

7. The SDN switch of claim 1, wherein the machine-learning in (d) is deep learning.

8. The SDN switch of claim 1, wherein the deep learning is performed using either a software or a special purpose hardware.

9. The SDN switch of claim 1, wherein the local controller receives periodic model updates from the centralized controller after each successful training session.

10. The SDN switch of claim 1, wherein the local controller further comprises: a first interface communicating with the centralized controller to receive model updates as a result of an external training session using machine learning, a second, control, interface communicating with the forwarding engine to send/receive control packets, and a third interface communicating with the trigger function to receive activation and deactivation triggers.

11. A method as implemented in an SDN switch,
the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller,
the method comprising:
(a) when the trigger is activated, sending at least a portion of the control traffic to the local controller residing in the SDN switch, and when the trigger is not activated, sending all control traffic to the centralized controller; and
(b) when the trigger is de-activated after being activated, then switch-back all control traffic from the local controller to the centralized controller.

12. A method as implemented in an SDN switch,
the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table, (4) a local controller to provide at least one control function of the centralized controller internally, wherein the local controller is trained externally by machine-learning for the at least one control function that is specific to the SDN switch; and (5) a trigger function to activate the local controller when a trigger is observed within the SDN switch and to divert at least a portion of a control traffic towards the local controller to provide the at least one control function, in lieu of sending the portion of the control traffic to the centralized controller,
the method comprising:
(a) switching over from using a centralized controller to a local controller residing within the SDN switch when one of or a plurality of pre-programmed triggers is activated;
(b) when any of the pre-programmed triggers in (a) are activated, sending only a corresponding control traffic to the local controller while sending rest of the control traffic to the centralized controller; and
(c) when any of the pre-programmed triggers in (a) are de-activated after being activated, then switching-back that corresponding control traffic from the local controller to the centralized controller.

13. An article of manufacture comprising non-transitory computer storage medium storing computer readable program code which, when executed by a processor in a single node, implements an SDN switch, the SDN switch comprising: (1) a plurality of ports to send/receive data, an incoming port within the plurality of ports, receiving a data packet from a first switch, and an outgoing port within the plurality of ports, sending the data packet to a second switch; (2) a forwarding engine to perform packet forwarding from the incoming port to the outgoing port according to one or more rules in a locally stored flow table; (3) another port in the plurality of ports to send/receive control packets to/from a centralized controller to construct the locally stored flow table; the non-transitory computer storage medium comprising:
(a) computer readable program code implementing a local controller to provide at least one control function of the centralized controller internally, wherein the local controller is trained externally by machine-learning for the at least one control function that is specific to the SDN switch; and
(b) computer readable program code implementing a trigger function to activate the local controller when a trigger is observed within the SDN switch and to divert at least a portion of a control traffic towards the local controller to provide the at least one control function, in lieu of sending the portion of the control traffic to the centralized controller.

14. The article of manufacture claim 13, wherein the trigger function is implemented as a violation of a threshold, wherein the threshold is any of the following: an increase in number of data packets, an increase in the number of control packets, an increase in the number of table-miss during a specified time interval, an increase in a total number of flow table entries, or an increase in a Ternary Content Addressable Memory (TCAM) capacity usage.

15. The article of manufacture of claim 13, wherein the trigger function is implemented as any of the following: a detection of heavy congestion of a control connection associated with the SDN switch, a detection of failure of a control connection associated with the SDN switch, a detection of heavy congestion of the centralized controller, or a detection of failure of the centralized controller.

16. The article of manufacture of claim 13, wherein the trigger function is programmed into the switch and updated time-to-time by either the centralized control or via a manual interface.

17. The article of manufacture of claim 13, wherein the local controller and the trigger function are trained external to the SDN switch using machine learning with a training dataset, the training dataset is at least control packets of the SDN switch collected over a period of time from any of the following: the centralized controller, a scrubbing center, or a simulated dataset.

18. The article of manufacture of claim 17, wherein the training dataset is pre-processed to discard repetitive, useless or corrupt data.

19. The article of manufacture of claim 13, wherein the machine-learning in (d) is deep learning.

20. The article of manufacture of claim 19, wherein the deep learning is performed using either a software or a special purpose hardware.

21. The article of manufacture of claim 13, wherein the local controller receives periodic model updates from the centralized controller after each successful training session.

22. The article of manufacture of claim 13, wherein the local controller further comprises: a first interface communicating with the centralized controller to receive model updates as a result of an external training session using machine learning, a second, control, interface communicating with the forwarding engine to send/receive control packets, and a third interface communicating with the trigger function to receive activation and deactivation triggers.
